(19) United States
(12) Patent Application Publication
(10) Pub. No.: US 2007/0130245 A1
(43) Pub. Date: Jun. 7, 2007

(54) Portable internet terminal apparatus for wireless broadband internet

(75) Inventors: Woon Seob So, Daejeon-city (KR); Do Young Kim, Daejeon-city (KR); Hae Won Jung, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/634,640

(22) Filed: Dec. 6, 2006

(30) Foreign Application Priority Data
Dec. 7, 2005 (KR) 10-2005-0118630
Jul. 6, 2006 (KR) 10-2006-0063470

(51) Int. Cl. G06F 15/16

(52) U.S. Cl. 709/200

(57) ABSTRACT

Provided is a portable Internet terminal apparatus for wireless broadband Internet, including: a processor core unit controlling a wireless Internet connection or a wired Internet connection if the wireless connection to the Internet is difficult or impossible; a user input and output unit controlling connections to peripheral devices comprising a display, a key pad, and a transmitter and/or receiver to provide an input and output user interface for a user who uses the Internet provided under the control of the processor core unit; and a network access unit providing an Internet connection function under the control of the processor core unit.

### CROSS-REFERENCE TO RELATED PATENT APPLICATION

This application claims the benefits of Korean Patent Application No. 10-2005-0118630, filed on Dec. 7, 2005, and Korean Patent Application No. 10-2006-0063470, filed on Jul. 6, 2006, in the Korean Intellectual Property Office, the disclosures of which are incorporated herein in their entirety by reference.

### BACKGROUND OF THE INVENTION

1. Field of the Invention

The present invention relates to a portable internet terminal apparatus used in a network, and more particularly, to a portable internet terminal apparatus for wireless broadband internet, wherein the apparatus is capable of providing a voice telephoning function and internet connection function through the Internet free of charge or at a very low cost.

2. Description of the Related Art

Communication terminals using the Internet comprise wired Internet telephone communication terminals and wireless Internet telephone communication terminals such as Bluetooth, which are separately formed and have limited use. Internet telephone terminals using a wireless local area network (LAN) have been separately developed. Dual mode terminals using a mobile network and a wireless LAN using code division multiple access (CDMA) and a global system for mobile communications (GSM) have also been developed.

However, in this case of a wireless LAN or Bluetooth, an internet telephone terminal is used only in limited places. If a dual mode terminal is used, the mobile network should be replaced with an Internet Protocol (IP) network. However, this replacement, as well as call processing in such a system, is complicated.

Various apparatuses having different functions are used to form a communication terminal apparatus having the above-described function. However, the circuitry for implementing the communication terminal apparatus is large and complicated. As a result, it is difficult to design and develop terminal apparatuses, a large amount time is required for development, and the cost of the developed terminal apparatuses increases. For example, a household in which the Ethernet is not installed requires an asymmetric digital subscriber line (ADSL) modem having an Ethernet port, an Internet telephone set having a wire Ethernet port or an ADSL modem having an Ethernet port so it can communicate using Bluetooth, and a Bluetooth Internet telephone set, so as to perform Internet telephoning. Accordingly, it is difficult to use a portable apparatus appropriate for various communication environments.

### SUMMARY OF THE INVENTION

The present invention provides a portable Internet terminal apparatus for wireless broadband Internet, wherein the apparatus is connected to the wireless broadband Internet wherever possible and via an Ethernet environment when not connected to the wireless broadband Internet.

According to an aspect of the present invention, there is provided an apparatus for a portable Internet terminal for wireless broadband Internet, the apparatus comprising: a processor core unit controlling a wireless Internet connection or a wired Internet connection if the wireless Internet connection is difficult or impossible; a user input and output unit controlling connections to peripheral devices comprising a display, a key pad, and a transmitter and/or receiver to provide an input and output user interface for a user who uses the Internet provided under the control of the processor core unit; and a network access unit providing an Internet connection function under the control of the processor core unit.

According to another aspect of the present invention, there is provided an apparatus for a portable Internet terminal for wireless broadband Internet, the apparatus comprising: a communication service controller controlling a wireless Internet connection or a wired Internet connection if the wireless Internet connection is difficult or impossible, controlling connections to peripheral devices comprising a display, a key pad, and a transmitter and/or receiver, providing an input and output user interface for an Internet user, and providing functions of the wireless and wired Internet connections; a resetter providing a reset signal necessary for the communication service controller; a clock unit providing a clock signal necessary for the communication service controller; a display connected to the communication service controller, for displaying necessary information to the user; a key pad connected to the communication service controller receiving and transmitting data input from the user; a transmitter and/or receiver connector providing a function of transmitting and/or receiving voice to the communication service controller by using mobile communication or a VoIP connection; a USB connector providing a USB connection function to the communication service controller; an Ethernet connector providing an Ethernet connection function to the communication service controller; a memory connected to the communication service controller and storing an application program, user data, and an application program for providing a service to the user; and a wireless connector connected to the communication service controller so as to provide a function of connecting to a base station so as to provide the wireless Internet connection.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a portable Internet terminal apparatus for wireless broadband Internet according to an embodiment of the present invention;

FIG. 2 is a schematic block diagram illustrating a detailed structure of the apparatus shown in FIG. 1;

FIG. 3 is a schematic block diagram of a portable Internet terminal apparatus for wireless broadband Internet according to another embodiment of the present invention;

FIG. 4 is a view illustrating a portable Internet terminal apparatus for wireless broadband Internet according to an embodiment of the present invention, wherein the apparatus is used in an Ethernet connection environment; and

FIG. 5 is a view illustrating a portable Internet terminal apparatus for wireless broadband Internet, wherein the apparatus is used in a wireless Internet environment according to an embodiment of the present invention.

### DETAILED DESCRIPTION OF THE INVENTION

Hereinafter, embodiments of the present invention will be described in detail with reference to the attached drawings.

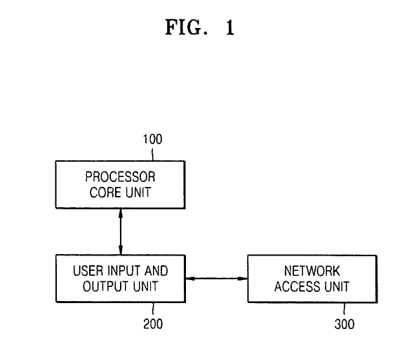

FIG. 1 is a block diagram of a portable Internet terminal apparatus for wireless broadband Internet according to an embodiment of the present invention. The apparatus may be realized as a single stand-alone part that is included inside the portable Internet terminal and performs a core function.

The apparatus includes a processor core unit 100, a user input and output unit 200, and a network access unit 300. The processor core unit 100 controls a wireless Internet connection and controls a wired Internet connection if the wireless Internet connection is difficult or impossible. The user input and output unit 200 controls connections to peripheral devices including a display, a key pad, and a transmitter and/or receiver and provides an input and output user interface for a user who uses the Internet provided under the control of the processor core unit 100. The network access unit 300 provides an Internet connection function under the control of the processor core unit 100.

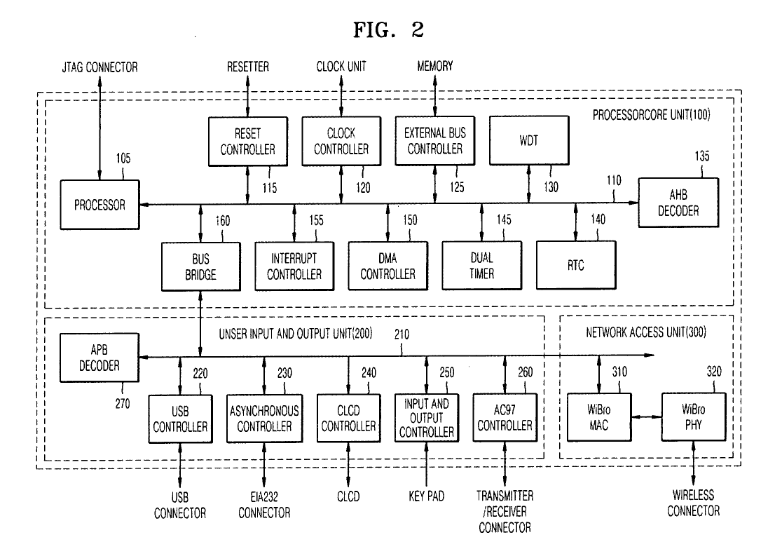

FIG. 2 is a schematic block diagram illustrating a detailed structure of the apparatus shown in FIG. 1.

The processor core unit 100 includes a processor 105, a reset controller 115, a clock controller 120, an external bus controller 125, a watch dog timer (WDT) 130, an advanced high-performance bus (AHB) decoder 135 that is a processor bus decoder, a real-time clock (RTC) 140, a dual timer 145, a direct memory access (DMA) controller 150, an interrupt controller 155, and a bus bridge 160. The processor 105 is connected to an AHB 110 which is a processor bus inside the processor core unit 100.

The user input and output unit 200 includes an advanced peripheral bus (APB) decoder 270, a universal serial bus (USB) controller 220, an asynchronous controller 230, a color liquid crystal display (CLCD) controller 240, a general purpose input/output (GPIO) controller 250, and an audio codec 97 (AC97) controller 260. The APB decoder 270 is connected to an APB 210 that is a peripheral bus inside the user input and output unit 200. The CLCD controller 240 controls a CLCD that is an example of a display.

The network access unit 300 includes a wireless broadband media access control (WiBro MAC) controller 310 connected to the APB 210 and a wireless broadband physical layer (WiBro PHY) 320 connected to the WiBro MAC controller 310.

The processor 105 operates as a 32-bit reduced instruction set computer (RISC) microprocessor which processes all control blocks of the apparatus illustrated in FIG. 1 or 2 according to an embodiment of the present invention.

The processor 105 has a debugging connection function for debugging a software program executed in a processor core. To this end, a Joint Test Action Group (JTAG) connection function can be provided.

If the processor 105 detects that the strength of a wireless Internet signal is less than or equal to a predetermined reference level, the processor 105 determines that the wireless Internet connection is difficult or impossible and enables the wired Internet connection.

The AHB 110 provides a transmission path for signals including an address signal, a data signal, and a control signal and is connected to function blocks of the processor core unit 100.

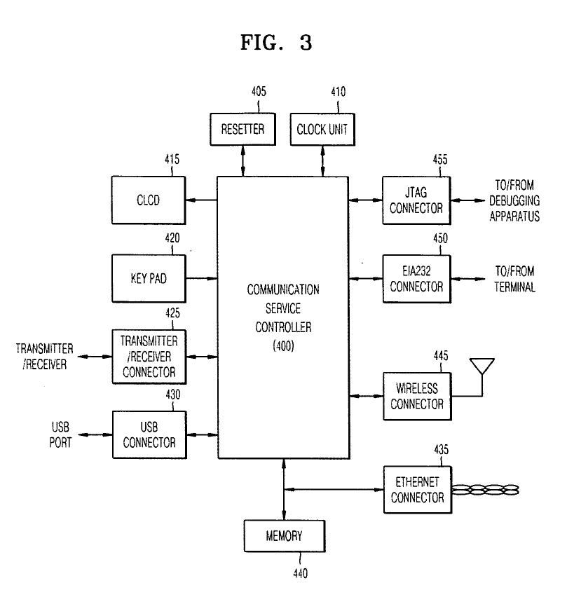

The reset controller 115 is connected to a reset unit, which will be described later with reference to FIG. 3, in order to initialize all control blocks of the processor core unit 100 according to a reset signal input from an external source. The reset controller 115 also generates a reset signal necessary for the control blocks and the reset signal is carried via the AHB 110.

The clock controller 120 is connected to a clock unit in order to receive a clock signal input from an external source, e.g., a 25 MHz clock signal, passes the clock signal through a phase lock loop (PLL), and generates various clock signals that are necessary inside the processor core unit 100.

The external bus controller 125 generates a control signal at a predetermined time, wherein the control signal is necessary for reading data from a memory or writing data to the memory, examples of which are a flash memory, a synchronous dynamic memory, or a memory map type device. In the present embodiment, an Ethernet connection function for the wired Internet connection is provided. The network access unit 300 may provide a function for the wired Internet connection.

The WDT 130 periodically interrupts a program to watch a program execution procedure.

The AHB decoder 135 decodes access areas of the control blocks connected to the AHB 110. The AHB decoder 135 combines signals including addresses corresponding to the access areas of the control blocks in order to generate a signal indicating an access to a corresponding area so as to access an access area of a desired control block.

The RTC 140 provides time information based on a 1 Hz clock. As a result, the RTC 140 computes a time, a second, a minute, an hour, a date, a month, and a year.

The dual timer 145 includes two timers for receiving a predetermined reference clock so as to generate a timing signal appropriate for a time designated in a program.

The DMA controller 150 generates and provides a control signal necessary for rapidly transmitting and/or receiving data between the control blocks of the processor core unit 100 and a main memory without intervention by the processor 105.

The interrupt controller 155 processes various internal and external interruptions occurring in the execution of the program.

The bus bridge 160 matches a data signal, an address signal, and a control signal so that a bus between the AHB 110 and the APB 210 is synchronized with each bus.

The APB 210 provides a path through which signals including an address signal, a data signal, and a control signal of the user input and output unit 200 are transmitted and/or received. Also, the all function blocks of the user input and output unit 200 are connected to the APB 210.

The APB decoder 270 decodes access areas of control blocks connected to the APB 210.

The USB controller 220 provides a USB 1.0 or USB 2.0 interface for connection to a USB port.

The asynchronous controller 230 provides a function of controlling a universal asynchronous receiver/transmitter (UART), controls data input and output at a speed of 230.4 kbps to perform an EIA232 communication, and processes the data according to a UART protocol.

The CLCD controller 240 provides a function of controlling a display and generates and controls CLCD data, a synchronous signal, and a clock signal so as to output color data information to a CLCD externally connected by means of a high speed connection.

The input and output controller 250 processes input and output signals used as various control signals, and a key pad data input and a light emitting diode (LED) driving signal are generally connected to the input and output controller 250.

The AC 97 controller 260 operates as a transmitter and/or receiver connector for transmission and/or reception in wireless mobile communication or a Voice-Over-Internet Protocol (VoIP), wherein the transmitter and/or receiver connector will be described later with reference to FIG. 3. The AC 97 controller 260 provides a function of transmitting and/or receiving voice or audio pulse code modulation (PCM) data sampled at 8 bits or 16 bits.

The WiBro MAC controller 310 processes a WiBro MAC function protocol according to IEEE 802.16 MAC standards.

The WiBro PHY 320 is directly connected to the WiBro MAC controller 310 and operates an orthogonal frequency division multiplexing access (OFDMA) modem according to IEEE 802.16PHY standards. The WiBro PHY 320 may operate as a modem supporting wireless Internet standards.

A measurement of the strength of a signal received through the WiBro PHY 320 and the WiBro MAC controller 310 is transmitted to the processor 105. As described above, if the processor 105 detects that the intensity of the wireless Internet signal is less than or equal to the predetermined reference level, the processor 105 determines that the wireless Internet connection is difficult or impossible and enables the wired Internet connection.

FIG. 3 is a schematic block diagram of a portable Internet terminal apparatus for wireless broadband Internet according to another embodiment of the present invention.

The apparatus includes a communication service controller 400, a resetter 405, a clock unit 410, a CLCD 415, a key pad 420, a transmitter and/or receiver connector 425, a USB connector 430, an Ethernet connector 435, a memory 440, a wireless connector 445, an EIA232 connector 450, and a JTAG connector 455. The communication service controller 400 controls a wireless Internet connection, and controls a wired Internet connection if the wireless Internet connection is difficult or impossible. The communication service controller 400 also controls connections to peripheral devices including a display, a key pad, and a transmitter and/or receiver, provides an input and output user interface to an Internet user, and provides wireless and wired Internet connections. The resetter 405 provides a necessary reset signal to the communication service controller 400. The clock unit 410 provides a clock signal. The CLCD 415 displays necessary information to the user. The key pad 420 receives data from the user. The transmitter and/or receiver connector 425 provides a function of transmitting and/or receiving voice by using mobile communication or a Voice-Over-Internet Protocol (VoIP). The USB connector provides a connection to a USB. The Ethernet connector 435 provides an Ethernet connection. The memory 440 stores an application program, user data, and application programs providing services to the user. The wireless connector 435 provides a wireless connection to a base station and a wireless Internet connection. The EIA232 connector 450 provides a connection to a portable Internet terminal. The JTAG connector 455 provides a connection to another debugging apparatus.

The communication service controller 400 has the same function as the apparatus illustrated in FIG. 2.

The resetter 405 provides a power input reset signal and a switch reset signal to the communication service controller 400 for a necessary period of time.

The clock unit 410 provides a 25 MHz clock signal necessary for the apparatus illustrated in FIG. 3. The 25 MHz clock signal is input to the communication service controller 400, divided and doubled, and provided to constituent blocks.

The CLCD 415 is connected to the communication service controller 400 through 24-bit data signals, for example, CLD0 through CLD23, a data clock DCLK, a data enable signal DEN, a vertical synchronous signal VSYNC, and a horizontal synchronous signal HSYNC, in order to display all states of the apparatus and messages necessary for a user. The displayed messages include a current state of a telephone, transmitted and received telephone numbers, a current time, a date, a day, an intensity of a received signal, information regarding residual amount of a battery, etc. The communication service controller 400 may be programmed to add and delete various messages.

The key pad 420 uses 12 basic key buttons for dialing a telephone number, * and # and 8 auxiliary key buttons for an additional service function. Auxiliary key buttons may include a menu key, a confirmation key, a dialing key, a telephoning end key, a function setting key, etc.

The transmitter and/or receiver connector 425 provides voice transmitting and receiving functions to the communication service controller 400 by using mobile communication or a VoIP connection. In other words, the transmitter and/or receiver connector 425 performs a function of connecting to a transmitter and/or receiver of a voice signal, converts various tone signals and the voice signal into digital or analog signals, and amplifies the analog signals. Here, a microphone and speaker are connected to the transmitter and/or receiver connector 425 so that the transmitter and/or receiver connector 425 can operate as a speaker phone.

The USB connector 430 is connected to a USB port by using a plus data signal DP and a minus data signal DM to transmit and/or receive data.

An Ethernet device may be connected to a memory bus between the communication service controller 400 and the memory 440 in memory map form so as to realize the Ethernet connector 435. Thus, the Ethernet connector 435 performs functions of an Ethernet MAC and an Ethernet PHY.

For example, the Ethernet connector 435 is connected to the communication service controller 400 by using address signals A0 through A14, data signals D0 through D31, a chip selection signal ECS, a data read signal MA_OE, a data write signal MA_WE, an interrupt signal EIRQ, bite enable signals EBE0 through EBE3, and a reset signal RESET. The Ethernet connector 435 is connected to an Ethernet line by using an output data plus signal TPOP, an output data minus signal TPOM, an input data plus signal TPIP, and an input data minus signal TPIM to transmit and/or receive data.

The memory 440 is directly connected to the communication service controller 400, stores a start program or a terminal apparatus application program, and includes a flash read only memory (FROM) which may be connected to 8-bit, 16-bit, and 32-bit buses. The memory 440 temporarily stores various application programs and includes a synchronous dynamic random access memory (SDRAM) which may be connected to 8-bit, 16-bit, and 32-bit buses. The memory 440 may also be connected to an external memory device which can be accessed by the memory 440 in memory map form.

For example, the wireless connector 445 is connected to the communication service controller 400 by using baseband control data B0 through B7, serial input data DIN, a serial data clock signal SCLK, a chip selection signal WCS, a transmission enable signal TXENA, a reception enable signal RXENA, a shutdown signal SHDN, a received frequency control signal RXHP, a control signal and output Q channel differential data signals RXBBQ+ and RXBBQ− of a received intensity signal RSSI, output I channel differential data signals RXBBI+ and RXBBI−, input Q channel differential data signals TXBBQ+ and TXBBQ−, and data signals of input I channel differential data signals TXBBI+ and TXBBI−, so as to process 2.3 GHz band data for wireless transmission.

The EIA232 connector 450 is connected to a terminal for a monitor by an ELA232 port. For example, the EIA 232 connector 450 includes a signal level driver and receiver and is connected to the communication service controller 400 by using a transmitted data signal TXD, a received data signal RXD, a transmission request signal RTS, and a receiving ready signal CTS to transmit and/or receive data.

The JTAG connector 455 may be connected to a processor (105 of FIG. 2) of the communication service controller 400 in order to connect the processor to a Multi-ICE or RealView so as to debug a software program executed in the processor. For example, the JTAG connector 455 has signals of an input data signal TDI, an output data signal TDO, a data clock signal TCK, and a reset signal TRST to transmit and/or receive debugging information.

The apparatus of an embodiment of the present invention realized as described above may be directly connected to the Ethernet or may be wirelessly connected to an Internet network by using a high speed portable Internet connection so as to provide a voice telephoning function and an Internet connection function to a user through the Internet.

Also, the apparatus is not limited to the above-mentioned functions and may be used as a communication terminal apparatus capable of processing various functions demanded by a user by simply changing and adding functions. For example, if a video signal processing device is added, the apparatus may be used as an Internet video telephoning terminal apparatus. If a digital multimedia broadcasting (DMB) receiving device is added, the apparatus may be used as a DMB receiving terminal apparatus. If a global positioning system (GPS) receiving device is added, the apparatus may be used as a GPS receiving terminal apparatus.

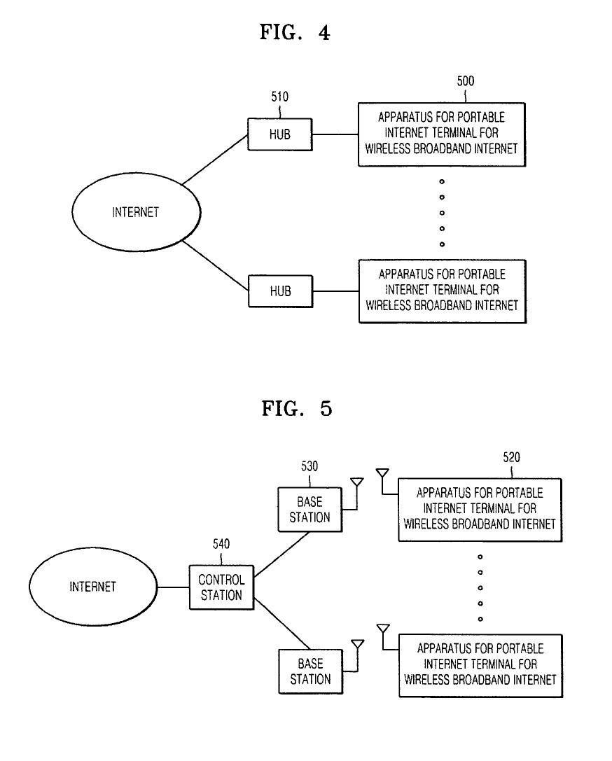

FIG. 4 is a view illustrating a portable Internet terminal apparatus 500 for wireless broadband Internet according to an embodiment of the present invention, wherein the apparatus 500 is used in an Ethernet connection environment. The apparatus 500 may be connected to the Internet through a hub 510.

FIG. 5 is a view illustrating a portable Internet terminal apparatus 520 for wireless broadband Internet according to an embodiment of the present invention, wherein the apparatus is used in a wireless Internet environment. The apparatus 520 is connected to a radio access station (RAS) 530 of a portable Internet system that is to be connected to the Internet through a control station 540.

As described above, a portable Internet terminal apparatus for a wireless broadband Internet according to the present invention can include a processor core unit, a user input and output unit, and a network access unit. The processor core unit controls a wireless Internet connection or a wired Internet connection if the wireless Internet connection is difficult or impossible. The user input and output unit controls connections to peripheral devices including a display, a key pad, and a transmitter and/or receiver in order to provide an input and output user interface for a user who uses the Internet provided under the control of the processor core unit. The network access unit provides an Internet connection function under the control of the processor core unit. Thus, a controller for a communication service into which functions necessary for an Internet telephone are integrated can be used to minimize constituent parts so as to easily design the apparatus. Also, the apparatus can be simply formed, low-priced, and small so as to be connected to a portable Internet connection. If the apparatus is not connected to a wireless network, the apparatus can be connected to the Ethernet. In addition, since the apparatus has a simple structure, the apparatus can be easily maintained, repaired, and is highly reliable. Hardware having various functions and software can be added to the apparatus. As a result, the apparatus can be used a multi-purpose communication terminal apparatus in various fields.

Also, it will be understood by those of ordinary skill in the art that the present invention can be realized using software or hardware adopting a general programming technique.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for a portable Internet terminal for wireless broadband Internet, comprising:
a processor core unit controlling a wireless Internet connection or a wired Internet connection if the wireless Internet connection is difficult or impossible;
a user input and output unit controlling connections to peripheral devices comprising a display, a key pad, and a transmitter and/or receiver to provide an input and output user interface for a user who uses the Internet provided under the control of the processor core unit; and
a network access unit providing an Internet connection function under the control of the processor core unit.

2. The apparatus of claim 1, wherein the processor core unit comprises:
a processor performing a central processing function of the apparatus, determining the wireless or the wired Internet connection, and controlling the wireless or wired Internet connection according to the determination result;
a processor bus transmitting and/or receiving signals comprising address, data, and control signals that are to be connected to function blocks of the processor core unit;
a reset controller initializing all functions of the apparatus according to a predetermined reset signal and generating a reset signal necessary for the apparatus, wherein the reset signal is transmitted through the processor bus;
a clock controller receiving a predetermined clock signal in order to generate clocks necessary inside the apparatus;
an external bus controller controlling a connection to one of a flash memory connected from outside of the apparatus, a synchronous dynamic memory, and a memory map type device and providing an Ethernet connection function for the wired Internet connection;
a WDT (watch dog timer) periodically generating an interruption in order to watch a program executing procedure;
a processor bus decoder decoding access areas of function blocks connected to the processor bus;
a RTC (real-time clock) counting seconds based on a 1 Hz clock signal in order to compute a time;
a dual timer comprising two timers and receiving a predetermined reference clock signal in order to generate a timing signal at a designated time;
a DMA (direction memory access) controller controlling transmission and/or reception between controllers of the processor core unit and a main memory without intervention by the processor; and
an interrupt controller processing internal and external interruptions occurring during the execution of a program.

3. The apparatus of claim 2, wherein the processor core unit further comprises a bus bridge matching signals between the processor bus and a peripheral bus of the user input and output unit.

4. The apparatus of claim 2, wherein the processor has a debugging connection function of debugging a software program executed in the processor core unit.

5. The apparatus of claim 1, wherein the user input and output unit comprises:
a peripheral bus transmitting and/or receiving signals comprising address, data, and control signals of the user input and output unit and connected to function blocks of the user input and output unit
a peripheral bus decoder connected to the peripheral bus in order to decode access areas of the function blocks;
a USB (universal serial bus) controller providing an interface for a connection to a USB port;
an asynchronous controller controlling EIA232 communication data and processing data input and output according to a UART (universal asynchronous receiver/transmitter) protocol;
a display controller generating video data, a synchronous signal, and a clock signal in order to output video data information to a display connected outside and controlling a display of a video;
an input and output controller processing input and output signals used as control signals comprising a key pad data input signal and an LED (light emitting diode) driving signal; and
an AC97 controller transmitting and/or receiving sampled voice or audio PCM (pulse code modulation) data and providing a path for voice data of a VoIP (Voice-Over-Internet Protocol) service.

6. The apparatus of claim 1, wherein the network access unit comprises:
a WiBro MAC (wireless broadband media access control) connected to the peripheral bus of the user input and output unit and processing a wireless Internet connection protocol comprising a MAC function protocol; and
a WiBro PHY (wireless broadband physical layer) connected to the WiBro MAC and operating in a wireless Internet mode comprising an OFDMA (orthogonal frequency division multiplexing access) modem function.

7. An apparatus for a portable Internet terminal for wireless broadband Internet, comprising:
a communication service controller controlling a wireless Internet connection or a wired Internet connection if the wireless Internet connection is difficult or impossible, controlling connections to peripheral devices comprising a display, a key pad, and a transmitter and/or receiver, providing an input and output user interface for an Internet user, and providing functions of the wireless and wired Internet connections;
a resetter providing a reset signal necessary for the communication service controller;
a clock unit providing a clock signal necessary for the communication service controller;
a display connected to the communication service controller, for displaying necessary information to the user;
a key pad connected to the communication service controller receiving and transmitting data input from the user;
a transmitter and/or receiver connector providing a function of transmitting and/or receiving voice to the communication service controller by using mobile communication or a VoIP connection;
a USB connector providing a USB connection function to the communication service controller;
an Ethernet connector providing an Ethernet connection function to the communication service controller;
a memory connected to the communication service controller and storing an application program, user data, and an application program for providing a service to the user; and
a wireless connector connected to the communication service controller so as to provide a function of connecting to a base station so as to provide the wireless Internet connection.

8. The apparatus of claim 1, further comprising:
an EIA232 connector connected to the communication service controller so as to provide a function of a connection to the portable Internet terminal; and
a JTAG (Joint Test Action Group) connector connected to the communication service controller so as to provide a function of a connection to another debugging apparatus.
